(19) United States
(12) Patent Application Publication
(10) Pub. No.: US 2013/0022951 A1
(43) Pub. Date: Jan. 24, 2013

(54) Individualized, genetically-determined dietary supplementation and exercise recommendation with container and dispenser for same

(71) Applicant: Timothy P. Hughes, Kingston, IL (US)

(72) Inventor: Timothy P. Hughes, Kingston, IL (US)

(21) Appl. No.: 13/136,041

(22) Filed: Jul. 21, 2011

(51) Int. Cl. G09B 23/28

(52) U.S. Cl. 434/262

(57) ABSTRACT

A method, system, and device for providing nutritional detailed dietary (menu planning), exercise, and life coaching guidance and nutritional supplements to maximize Wellness (health and fitness) to a person based on a portion of the person's genetic SNP profile, taking account of at least about 30 genes and variations therein. The person provides a tissue sample to a genetic analysis laboratory, which issues its SNP report. That report, together with the person's responses to a personal habits questionnaire, is analyzed by a nutritionist and also an exercise therapist and a monthly dietary supplementation plan and recommended lifestyle changes are provided to the person. A supplements box is provided to the person with daily and intra-daily doses of prescriptions and supplements, the box containing at least 4 weeks' worth of supplements. The box is filled and refilled monthly to the specifications of the nutritionist, exercise therapist, and lifestyle coach to assist the person in achieving optimum health and vitality, i.e., wellness.

### FIELD OF THE INVENTION

The present invention relates to providing dietary supplements and exercise recomendations needed by an individual, both in pill and/or capsule form and in powder form, as needed, to a person who has had a genetic profile made, such as a Gene SNP profile, in consultation with nutritionists, exercise therapists, lifestyle coaches, and medical practitioners as needed.

### BACKGROUND OF THE ART

Gene SNP profiles are available commercially, as with personal tissue taken with cotton swabs rubbed on the inner cheeks of a person's mouth. These swabs or other tissue samples are processed through the mail or by courier or package service, and the results are provided with certain general guidance to the person as to nutritional issues identified, and sometimes with general nutritional and/or exercise and other lifestyle guidance based at least loosely on the gene variants identified.

One example of diet-gene interactions and their relation to cancer risk comes from studies of the micronutrient selenium (Se), reported in J. Nutr. Jan. 1, 2007 vol. 137 no. 1 253S258S, at fn 23-26 (footnotes omitted). It is reported there that a body of epidemiologic evidence suggests that low Se intake is associated with increased risk of cancers. A large double-blind trial found that Se supplementation (200 μg/d) led to reduced mortality from colon and prostate cancer. A European study showed that over a 10-year period cancer mortality was lowest in the third of individuals with the highest plasma Se. Biochemical data show that Se is incorporated into a number of proteins as the amino acid selenocysteine during translation of the mRNA; in humans such selenoproteins have been identified. The selenocysteine is encoded by a UGA codon in the mRNA (this normally reads for STOP), and the recoding requires a structure in the 3′-untranslated region (3′UTR) of the mRNA (the selenocysteine insertion sequence or SECIS), a specific tRNA for selenocysteine, and specific binding proteins to allow reading of UGA as selenocysteine. Many of the physiological functions of Se are thought to result from its presence in selenoproteins. Therefore the genes encoding these proteins and the factors required for Se incorporation are prime targets for SNP studies in relation to Se and susceptibility to disease because, potentially, variations in DNA sequence within these genes could affect selenoprotein function. For example, a C-T variation within the protein coding region of the GPX1 gene leads to a Pro-Leu amino acid change, and this has been reported to affect enzyme activity. In addition, because Se incorporation involves the 3′UTR of the mRNA, it is possible that SNPs within the region of the gene encoding the 3′UTR, although they would not affect the protein itself, could affect synthesis of the selenoprotein and response to dietary Se; SNPs were found in the 3′UTR of both GPX4 and the 15-kDa selenoprotein. Detailed studies of SNPs in the factors involved in selenoprotein synthesis (SBP2, selenocysteine synthestase 2, and EFSec) have not been carried out, although recently a rare mutation on the SBP2 gene was identified. Selenoprotein P contains multiple selenocysteines, and knockout studies indicate that it has a major role in Se transport in the body. SNPs in selenoprotein P could therefore affect expression and function of a range of selenoproteins. An SNP within the protein-coding region of this gene was reported, but further studies are required to define its functionality. Research on diet-gene interactions and cancer risk has been supported by grants from the Biotechnology and Biological Sciences Research Council, the Food Standards Agency, and the World Cancer Research Fund. Thus, diet success is known to be affected by what gene variations a person has.

There is thus a need and opportunity for individualized nutritional, exercise, and life coaching guidance based on a person's gene profile. Supporting specific, genetically-determined nutritional needs with supplements for a person, based on their gene profile and a nutritionist's particularized, individual guidance, for easy administration and maintenance, has not been accomplished previously.

### SUMMARY OF THE INVENTION

It is an object of this invention to provide a system and method supported by modern gene analysis for recommending a person's monthly administration of detailed dietary (menu planning), exercise, and life coaching guidance and nutritional supplements to maximize Wellness (health and fitness). The invention in one facet comprises the steps of the process and a pill box having sections for each day of a multi-week period, with sub-sections as needed for morning, noon, and evening administration of pills and/or tablets, and including one or more bulk powder or granule containers for supplements or medications best provided in that form, as for mixing with liquid to make a drinkable fluid.

### BRIEF DESCRIPTION OF THE DRAWINGS

FIG. 1 is a flow chart of the processes of one facet of the present invention, from gathering and submission of a person's genetic samples, through machine analysis, nutritionist and exercise therapist review, and providing and filling compartments of a container with nutritional supplements keyed to the days and times for administration of same.

FIG. 2 is a plan view of a container made in accordance with one embodiment of the pillbox of the present invention.

FIG. 3 is a plan view of one sub-container useful in the present invention.

FIG. 4 is a plan view of another form of sub-container useful in the present invention.

### THE PREFERRED EMBODIMENTS

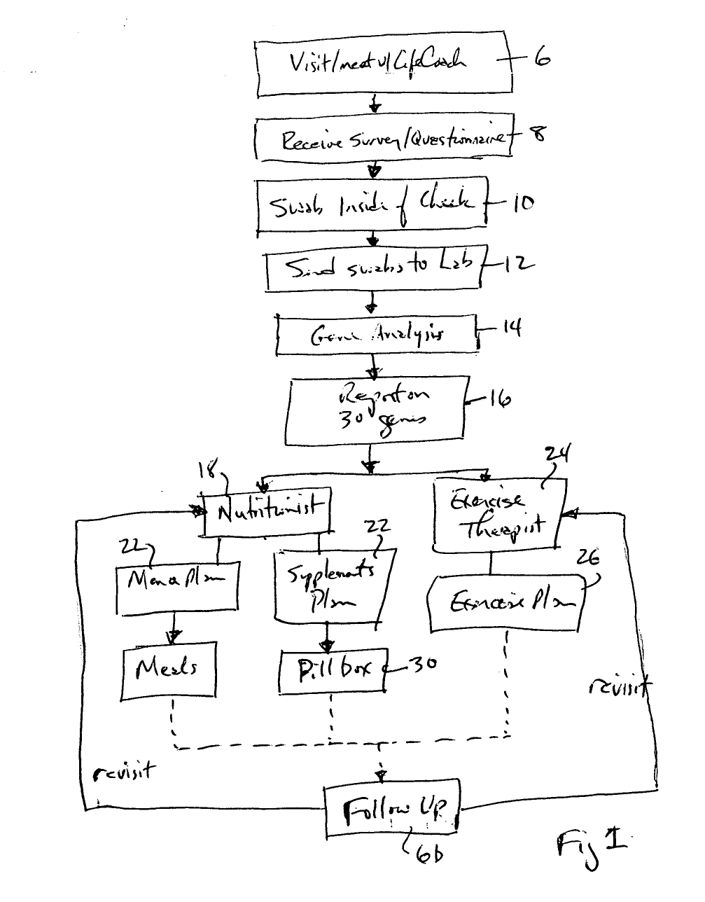

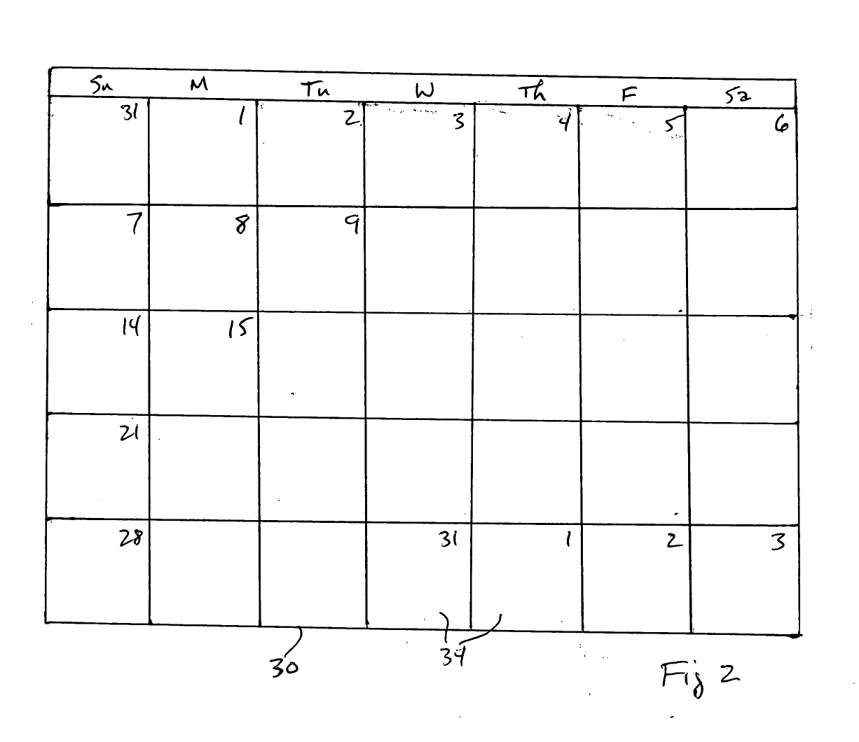

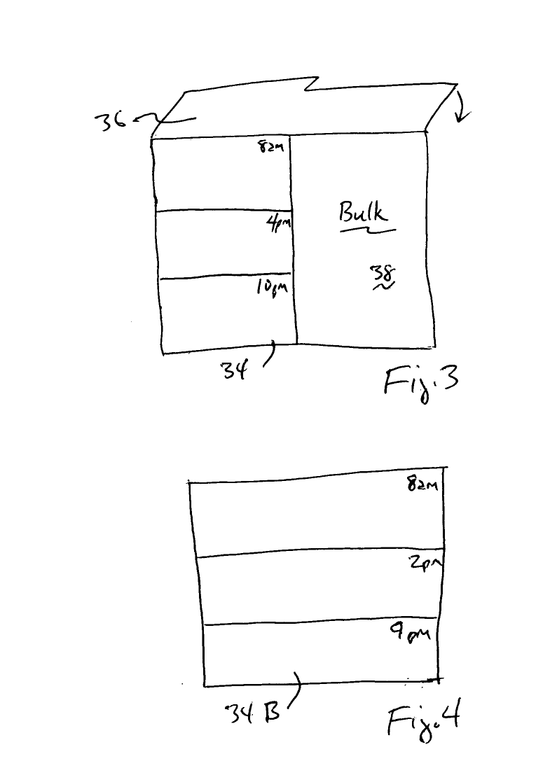

In one form and implementation of the present invention, a person confers in person with a Lifestyle Coach as at 6 in FIG. 1 and there receives information and instruction and obtains a gene analysis kit provided by a gene analysis laboratory or nutritional supply or other source. The person also obtains and may there fill out a personal medical, social, and lifestyle questionnaire form 8. He or she collects personal genetic material, such as cells from the inside of one or both cheeks of his or her mouth using for instance one or more cotton swabs 10 supplied in the kit, as instructed by the Lifestyle Coach at 6. Any other method of providing genetic material, including drawing of blood by a nurse, may be used as may be convenient and reliable. The swabs or other carriers of genetic materials are safely packed and mailed as at 12 to the gene analysis laboratory 14, such as the Gene SNP entity, found at >yourgenesnp.marketamerica.com <, which processes the genetic material from the swab to identify those genes and personal variations important for personal health and vitality, i.e., wellness. The laboratory generates a report 16 presenting to the person and his or her consultants the gene survey results. In accordance with the invention, the report 16 is then passed to a nutritionist 18, who is also in receipt of the personal medical, social, and lifestyle questionnaire 8 as filled in by the person or by his or her medical team and/or the genetics laboratory.

The nutritionist 18 may be a medical doctor or nurse practitioner or the like, trained in nutrition of the human body and its needs, deficiencies, and cures. He or she examines the genetic report 16 and the person's responses to the personal questionnaire. Based on his or her training and experience and on current professional and academic literature in the area, the nutritionist 18 devises a meal plan or menu 22A and a nutritional supplements plan 22B for the person. This plan will comprise the person's following a healthy dietary plan for hydration and foods and, as necessary, taking certain prescribed and other medications and any nutritional supplements that are indicated by the nutritionist 18 as needed or desirable for the person. For instance, supplementation with Selenium pills of up to 200 micrograms per day can be recommended and provided.

An exercise coach, as a physician or therapist, 24 is preferably also consulted by the person in connection with the genetic profile report 16 produced by the laboratory 14, in conjunction also with the nutritional plan 22 of the nutritionist 18. An exercise plan 26 is completed and provided, with suitable consultation, to the person whose genetic profile was taken.

Exactly how the nutritional plan 22 and the exercise plan 26 are devised, based on the genetic analysis report 16, is beyond the scope of this invention, but should accord with good and progressive medical and/or alternative medical research and thinking.

In accordance with principles of one form of the invention, the nutritional plan 22 of the nutritionist 18 is implemented for the person whose genetic profile was taken by means of a novel nutraceuticals container 30 that is filled and refilled for the person by a supplier or theirself. Daily doses, or more frequent, multiple doses each day as required, are provided in the container 30 in individual subcontainers 34.

The invention is appropriately implemented through an eight-step process, described as follows.

Step 1. The person meets with a Lifestyle Coach, as at 6 in FIG. 1, and obtains a Gene SNP DNA Analysis kit, gets prompted and instructed on how to take the Gene SNP sample, as with swabs 10, and as to do's and don'ts of the Gene SNP, including how to fill out the online profile and questionnaire form 8, and when to expect the results.

Step 2. When the results 16 come in, the person sets up an appointment with the Gene SNP Lifestyle Coach 6 and a nutritionist 18 to go over the results and build an individualized menu 22, to document lifestyle changes and what supplementation is needed based on the person's specific Genes. If supplements are needed a cocktail is customized for the person. The menu will be determined by the person's indicated ability to metabolize Vitamin B, his or her detoxification issues if any, indicated inflammation, heart health, bone health, insulin sensitivity, alcohol metabolism, and weight management issues. For instance, a person having an issue metabolizing Vitamin B needs 6 to 7 daily servings of vegetables. If in addition he or she has one stage not working in the body's ability to detoxify itself, then the person would need 8 to 9 servings of vegetables and 4 to 5 servings of fruit daily. However if the person has two stages with issues in detoxification then he or she would need 9 to 10 servings of vegetables and 8 to 9 servings of fruit per day. A menu or diet is created that will cover all body functions that can be altered by correct eating habits, by evaluating all 30 nutritional Genes and the seven areas of health, as noted.

Step 3. Next the person will meet with a Personal Trainer or Exercise Therapist 24 to go over their exercise habits and needs. A program will be designed by the Personal Trainer and agreed upon by the person. This program is to take into consideration the person's age, current abilities, lifestyle, and fitness goals as indicated by the Gene SNP and practices known by the Personal Trainer. Genes that are used to determine appropriate levels of exercise are, as presently advised, ACE, ADRB2, AGT, CETP, CRP, IL6, NOS3, PPARGC1A, and VDR, and/or other genes as new information comes out.

Step 4. The person will attend a weekly class on the person's Gene SNP recommendations and the progress made in implementing the changes into the person's life. Helpful ideas are provided to make sure all aspects of the specific recommendations are being implemented to maximize the person;s optimal health.

Step 5. The person also will attend a free monthly Seminar on what the 30 Genes and 42 variants are so as to help the person connect the dots as to his or her individual Genes. Seminars may also include “How Alpha-Liporic-Acid Works in the Mitochondria”, “How Oxidative Stress Interacts in the Body”, “How Oxidative Stress Ages the Body” and “How Diseases and Disorders Begin in the Body”. Classes in Steps 4 and 5 are designed to increase the person's compliance with all recommendations.

Step 6. The person will purchase classes and supplements used in the Low Glycemic Index Healthy Eating Lifestyle for 12 weeks or other weight management programs.

Step 7. The person will obtain an easy to use monthly pill box 30 to keep on track with his or her pharmaceutical and nutraceutical supplements. Containers within the pill box in one form may accommodate both pills and powders, as at 34, or not, as at 34B.

Step 8. After successfully implementing the changes in the person's Diet, Lifestyle, Exercise, and Supplementation as recommended by the nutritionist, the person would answer the questionnaire 8 for a second time and get new recommendations from the Lifestyle Coach 6 as a Follow-Up to optimize their health, to continue to refine and improve their wellness in view of their specific Genes.

The container 30 preferably comprises a month's array of daily dose sub-containers 34, set out in weekly arrangements, in four to six rows of seven days each. A top row of labels comprises the seven days of the calendar week, Sunday through Saturday or Monday through Sunday, as the filler and the person are comfortable with. Four to six rows of spaces for the seven daily doses are provided, so that the container 30 need only be refilled once a month by a quick replacement process while the person waits for a few minutes. Alternatively, if two such boxes are available, one can be refilled and provided to the person just before a prior one is used up; then the older one is returned for refilling. The person can also refill the box by theirself.

Each daily dose sub-container 34 has covered spaces for up to three or more pill-taking times, as morning, noon, and evening times; different containers as 34B may have fewer or larger spaces, as just for 8 am, 2 pm, and 8 pm, or for 8 am and 8 pm supplements. The sizes or volumes of each covered space can be determined empirically, as can the sizes of the container 30 and the sub-containers 34. Covers on the spaces are preferably provided, to make use of the subcontainers most facile, but are not required.

In addition to the spaces for the pills or capsules, each sub-container 34 may, in accordance with another facet of the invention, have a bulk space 38 for powders and granulated materials that are measured out with a spoon or small measuring cup. Whey protein powder is one example of such a supplement, used by mixing in water or juice. Isotonic blends are useful nutritional supplements and can be prepared from the powder mixture and selected liquid.

Many variations may be made in the invention as shown and its manner of use, without departing from the principles of the invention as described herein and/or as claimed as our invention. Minor variations will not avoid the use of the invention.

I claim as my invention:

1. In a method for maintaining or increasing a person's health and vitality, based on genetic SNP analysis of the person, the method comprising:
receiving tissue samples collected from the person, and
testing and analyzing the tissue samples for at least 30 genetic traits and variations keyed to health and nutrition variables,
the improvement comprising:
providing an individualized menu of foods and nutritional supplements for the person based on the genetic analysis and current nutritional concepts;
providing an individualized exercise program for the person based on the genetic analysis and current therapeutic concepts;
monitoring and encouraging the person's implementation of the menu and exercise program in at least weekly sessions to maximize the person's health;
providing educational and informative sessions to the person on how his or her genes interact with the menus and exercise program to optimize the person's health and fitness;
supplying nutritional supplements that the person needs, according to the gene profile, in daily and intra-daily compartments for easy administration and to encourage compliance with the menu; and
revisiting the health and vitality of the person to provide refinements and improvements to the person's health and fitness in view of results obtained and current nutritional and exercise concepts, and making any further recommendations for menu and exercise programs for the person.

2. In the method of claim 1, the further improvement of providing a supplementation box for the person, the box comprising a container and dispenser for the personal menu of supplementation to the diet noted as appropriate for the person, the supplementation being noted and selected based on the genetic testing of and analysis for said individual, the container and dispenser comprising:
an outer container with an openable lid and sides and a bottom forming an interior space when the box is closed by the lid, the interior space being divided into and by or for interior containers;
each said interior container having therein a plurality of sections, at least one for each of (a) specific supplementations and (b) bulk material comprising powdered or granulated material;
at least the section of the interior container for supplementations having an individual lid closing the top thereof; and
the interior containers being filled and positioned according to daily and weekly positions in a multi-week array of said interior containers in said box, according to the person's dietary supplementation needs as noted by and from said genetic analysis.

3. In the method with container and dispenser as defined in claim 2, said interior containers being removable from the box.

4. In the method container and dispenser as defined in claim 3, at least one of said interior containers has sections for morning and evening allocation and consumption of supplementations.

5. In the method with container and dispenser as defined in claim 2, at least one of said interior containers has sections for morning, mid-day, and evening allocation and consumption of supplementations.

6. In the method with container and dispenser as defined in claim 2, not all of the intenor containers are identical to one another in either of their sections and their contents of supplementations and/or bulk materials.

7. In the method with container and dispenser as defined in claim 1, the box holds at least four weeks' supply of supplementations and bulk materials.

8. In the method with container and dispenser as defined in claim 6, the interior of the box is divided into at least four rows and seven columns for interior containers, corresponding to days and weeks of a multi-week time span.

9. In the method with container and dispenser as defined in claim 8, the interior containers are labeled to span days of two sequential months.

10. In the method with container and dispenser as defined in claim 7, the interior of the box is divided into at least four rows of seven columns for interior containers, corresponding to days and weeks of about a month-long time span.

11. A method for providing pharmaceutical prescriptions and genetically-tailored dietary supplementation to a person based on genetic analysis of at least 30 genes and variants thereof in the person's DNA, the method comprising the steps:
obtaining and analyzing portions of a DNA profile of said person and creating a dietary supplementation regimen for said person;
dividing said regimen into daily, weekly, and monthly supplementation applications for said person according to nutritional principles based on said genetic profile; and
providing said person a multi-week supply of supplementations tailored to the person's needs based on said genetic profile, the supply being divided into allocations of same for consumption on designated days and hours as needed.

12. The method of claim 11, wherein the supply comprises both pill and bulk materials provided according to the person's needs as indicated by a nutritionist and based on the genetic analysis provided for the person.

13. The method of claim 11, wherein the method further comprises providing individualized counseling in nutrition and in exercise for the person to implement.
